(19) United States
(12) Patent Application Publication
(10) Pub. No.: US 2008/0281605 A1
(43) Pub. Date: Nov. 13, 2008

(54) Consultants - instrumentation loop logic diagrams

(76) Inventor: John Robert Davis, Cambridge, MA (US)

Correspondence Address: John R. Davis, 467 Bonnie Blvd, Palm Harbor, FL, 34684, US

(21) Appl. No.: 11/652,155

(22) Filed: May 10, 2007

(51) Int. Cl. G06Q 10/00

(52) U.S. Cl. 705/1

(57) ABSTRACT

The intent of the Process Loop Sheet is to convey information regarding how various pieces of equipment interact with a variable process design. For Instance, all Water and Wastewater Plants are designed to accommodate influent flow rates that are not consistent from one hour to the next. These flow rates are generally expressed as low flow rate, average daily flow rate, and maximum flow rate. In both types of plants there are generally pump stations, screenings and grit removal, clarifiers, filters, odor control, various types of chemical injections, and storage tanks. In addition there are typically local control panels communicating information about a particular process to a Central Control Room. Generally the major local control panels are provided with programmable logic controllers that interface through software with operator work stations that are located in the Central Control Room.

Due to the flow not being consistent flowing into plants, there needs to be a provision that equipment such as a pump can be started or stopped utilizing a level monitoring device to control the pump when an increasing or decreasing level change occurs in the tank. If an amount of various chemical needs to be injected in the process line depending on the influent flow rate then a flow meter needs to be in the process line monitoring and controlling the dosing rate into the pipe line.

These are some examples in why the Process Loop Sheets play a role in both Water and Wastewater Plant design. There needs to be a communication device that engineers, plant operators, and contractors can review and come to the same conclusion on the operation of that process. However not all loop sheets depict what is necessary for a complete operation. What is provided for your review is a better innovated design. In a previous attachment that I have sent, there are drawings showing designs of other consultants in 11″×17″ sheets. You may want to review their approach and mine for a better comparison. It is my opinion that there are very distinct difference between theirs and mine.

### PART 2: GENERAL

### 2.01 Format

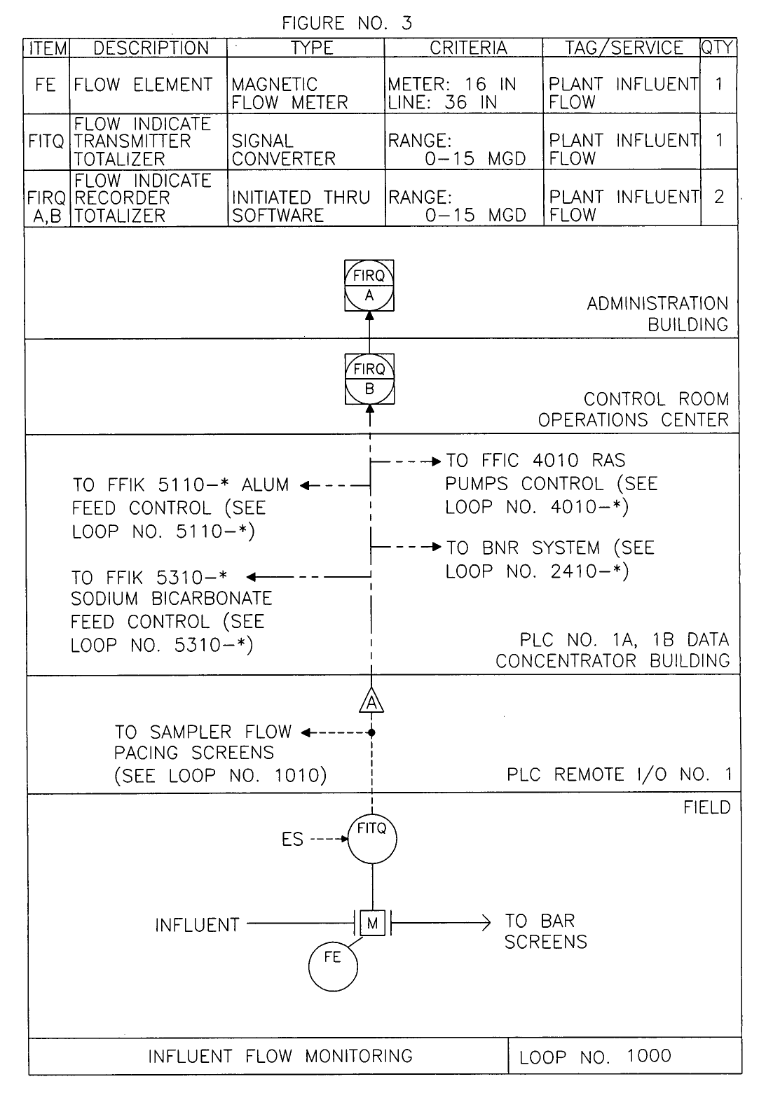

A. An Instrumentation process loop sheet shall depict a monitoring and control features of an instrumentation field device that is used to control a certain process or equipment in a Water or Waste Water Treatment Plant application. Refer to Sample Loop No. 1000 (FIG. 3) description below for detail explanation.

B. The process loop sheet shall utilize standard (ISA) Instrumentation, System, and Automation Society symbols and nomenclature. It is very important that a standardized symbol and nomenclature structure be used so any one person in the instrumentation field should be able to understand what any instrumentation engineer in any City, State or Country is trying to design.

C. The Loop name shall be a brief description of the process being monitored or controlled and shall be located at the bottom of the instrumentation process loop sheet.

D. The Loop number shall be a unique four digit number identifying the field equipment, and shall be located at the bottom right side of the instrumentation process loop sheet. It is important to note that there are many of the same types of instruments in both Water and Waste Water Facilities. That is why any and all devices and pieces of equipment should have there own unique assigned number. This unique loop number should not be used more than once at a given plant.

E. The Instrumentation process sheet can be divided in as many layers as required to show the entire path from the field to the control room. The field device shall always be located at the bottom end of process loop sheet with intermediate layers denoting local control panels, Remote I/O cabinets, PLC panels, fiber optic communication, etc, to the final designation of a control room location at the top end just below the description blocks of the equipment.

F. The layer or layers with controlling signals to other devices or equipment shall be denoted and labeled with their unique loop number designation at both ends for cross referencing.

### PART 3: PROCESS LOOP SHEET CRITERIA

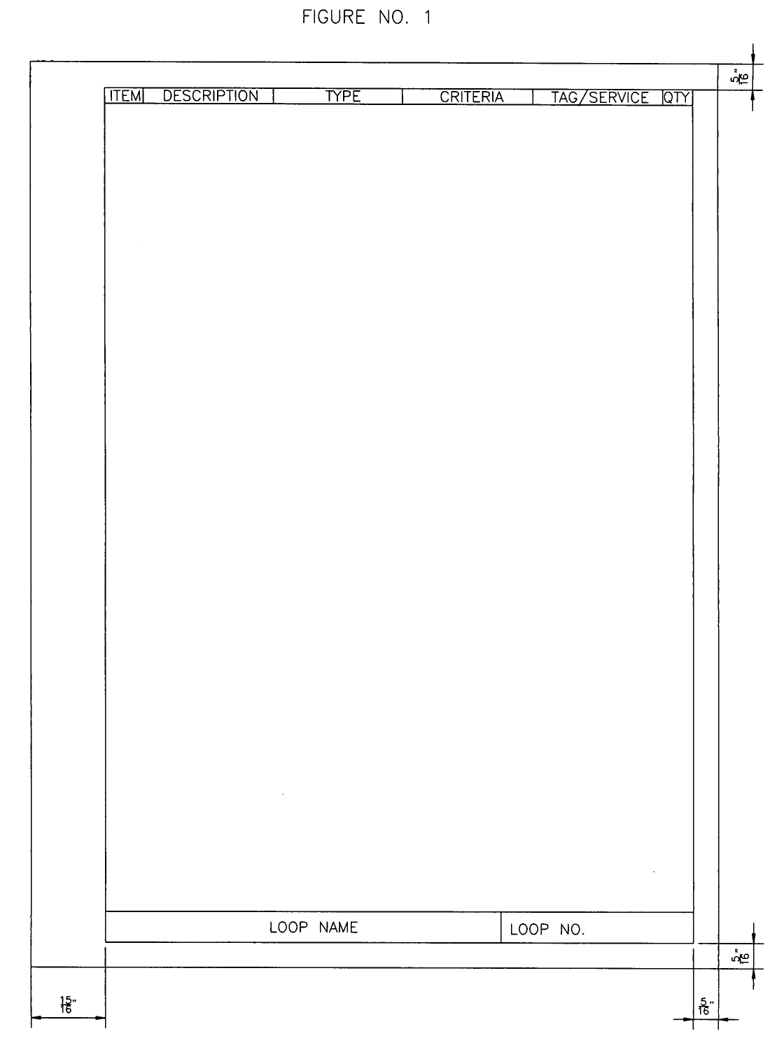

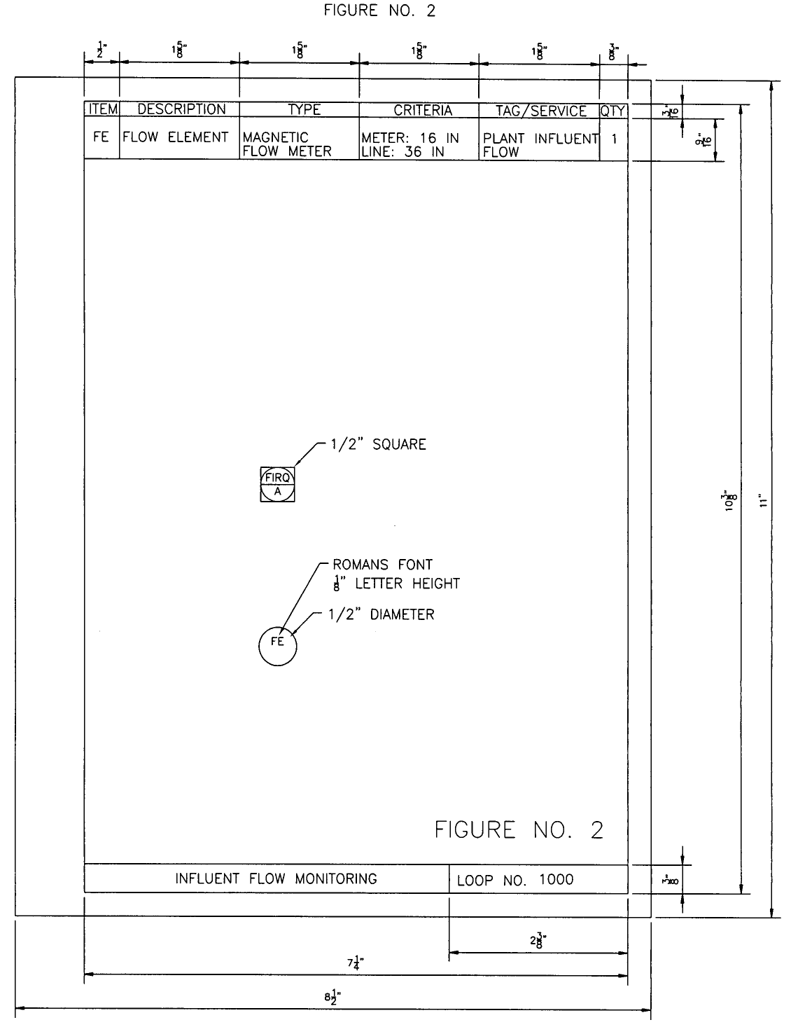

### 3.01 Dimensions (See FIG. 1 and FIG. 2)

A. The overall dimensions of the process loop sheet shall be 8.5″×11″. The left margin shall be 15/16″ to accommodate a three-hole punch, if required. The right margin shall be 5/16″, and the top, and bottom margin shall be 5/16″. These process loop sheets may be drawn by Hand or in Auto-Cad. In some cases where small projects occur and a few of the process loop sheets are required, placing the process loop sheets with the Engineering Specifications in a binder becomes a lot more efficient and manageable document.

B. The text font used is ROMANS which is one of standard in Auto-Cad fonts. This maybe user's choice when using Auto-Cad.

C. The text and numbers height shall be standard ⅛″ in Auto-Cad. This maybe user's choice when using Auto-Cad.

D. The dimensions for each description block are as follows as shown on (FIG. 2):
a. Item— 9/16″ h×½″ w
b. Description— 9/16″ h 1⅝″ w
c. Type— 9/16″ h 1⅝″ w
d. Criteria— 9/16″ h 1⅝″ w
e. Tag/Service— 9/16″ h 1⅝″ w
f. Quantity— 9/16″ h×⅜″ w

### 3.02 Description Blocks (See FIG. 3)

A. The description blocks include specific detailed information about all the instruments and components in an instrument process loop diagram. One description block shall be used per instrument or device. The description block is composed of from left to right, Item, Description, Type, Criteria, Tag/Service, Quantity and are described as follows:
a. Item—This area denotes the ISA abbreviation that is located in the circle with the unique process loop number. This is to make sure that each instrument or device which is represented by a circle is listed and accounted for on the loop sheet.
b. Description—This area explains the abbreviation in the item block. This allows an individual who is not accustomed to ISA standard nomenclature to understand the piece of equipment. In many cases a project manager is typically a Civil Engineer who meets with clients. There needs to be an easy way for the Civil Engineers, Electrical Engineers, Mechanical Engineers and a Client to understand the process loop sheet.
c. Type—This block becomes important due to the detail of the device. If the flow element (FE) was not identified as being either a Magnetic Flow Meter, a Venturi Flow Tube, an Ultrasonic Flow Meter, or etc. then others would not know.
d. Criteria—This information indicates which contractor is responsible to provide a certain piece of equipment. For instance, Mechanical Contractor (Division 15), Electrical Contractor (Division 16), or HVAC Contractor (Division 11). Typically each one of these contractors are assigned there own division number in the contract specifications. This block also allows information about a certain piece of equipment that is unique. For instance, the color of a pilot light lens, calibrated pressure, temperature, and flow range requirements, elevations of level switches, and analysis analyzer ranges.
e. Name Tag/Service—This area is used to identify each item and what it does in the process. This really helps individuals who do not understand the process of the plant requirement. This can also accommodate a person who might be putting a control panel together and requiring each piece of equipment on the panel to be identified by the process that is either being controlled or monitored.
f. Quantity—This identifies a certain amount of items, for instance, a control panel may have 3 red pilot lights. This helps the estimator who is bidding on the project as well as the panel manufacturer who is building the panel and even the purchaser who is buying the equipment.

### 3.03 Utility (See FIG. 3)

A. It was indicated previously that the full size 8½″×11″ process loop sheet can easily be attached to the contract specification documents if the project is small enough. On bigger projects the process loop sheets can also be placed on a full size 24″×36″ standard engineering contract drawing. Each contract drawing is large enough to hold eight individual process loop sheets. What makes this unique from other loop drawings is when a loop sheet needs to be changed or needs to be removed totally; the instrumentation design engineer does not need to affect the whole 24″×36″.

B. Drawings that have the process flow diagrams attached to ISA symbols often require more time to make changes due to the person needing to squeeze more information in or trying to fill a void on the drawing to make the drawing look professional. Since each process loop sheet is essentially a total cell, the process loop sheet may be remove in its entirety or altered without affecting the rest of the drawing.

C. One of the reasons that make the process loops sheets unique is the actual detail which does not show in other drawings that combine the process flow with the loops. Attached are common instrument drawings from various consultants for your review and understanding. You will note no quantities, equipment ranges, equipment sizes, interlocks, or a general idea what is going on with the process.

D. Other reasons that make the process loop sheets useful is when a design project goes out to bid there are generally contractor estimators that will use these process loop sheet drawings and do a quantity take off for a bill of materials. In addition, during final start up of a Water or Water Reclamation Plant the process loop sheets are used by the Instrumentation Engineer to check the work of the General Contractor.

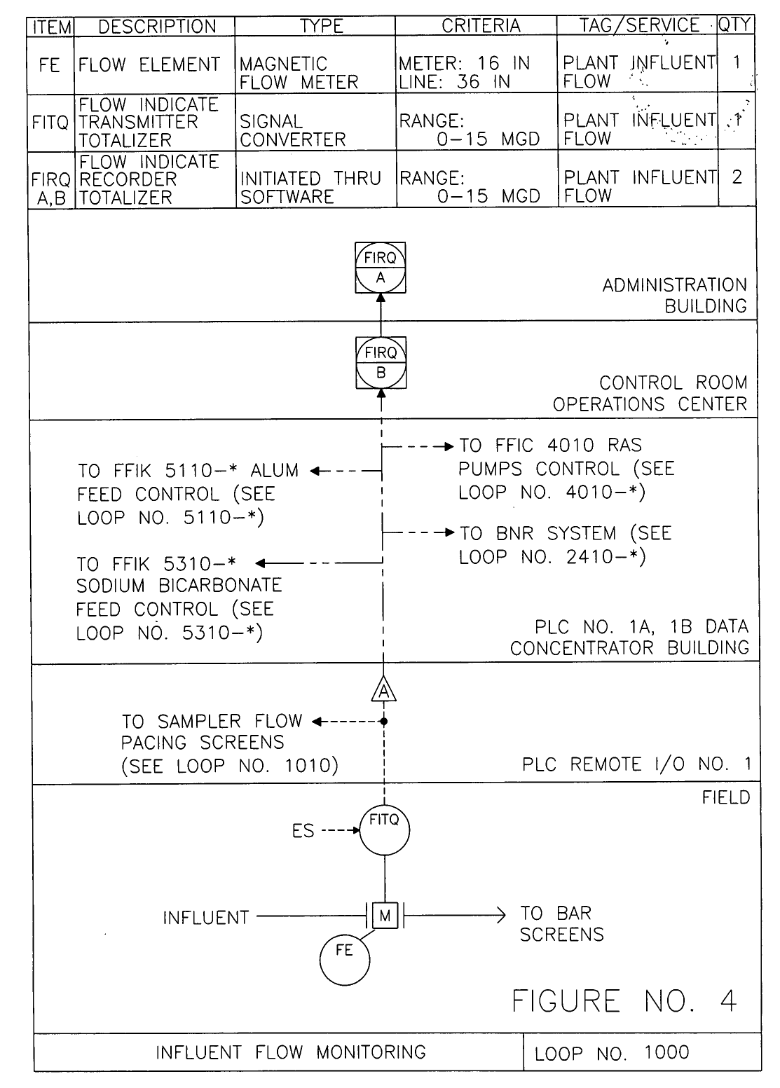

E. Since the coming of Intergraph and now Auto-Cad it has become more cost effective to save the process loops into certain files such as flow control loops, pressure control loops, level control loops, and pump stations. In most cases Water or Water Reclamation Plants do change there control strategies but maybe the size of their plants. Has you can see for instance, Loop 1000 (See FIG. 4) if the magnetic flow meter size on another plant was 24″ it won't take long to change the size and because it is a cell, copy and paste to another drawing to use again.

### 3.04 Sample—Loop No. 1000 (See FIG. 3) Interpretation

A. The attached Loop No. 1000 is an example of a monitoring and control process loop sheet.

B. This Instrumentation loop sheet depicts a magnetic flow meter that is used to control a sampling rate to the influent sampler by monitoring the actual influent flow rate to the wastewater plant and allowing the individual sample bottles to be filled, for instance, every 10,000 gallons of wastewater that is detected by the magnetic flow meter through the pipe.

C. In addition, various chemicals are depicted as being dosed into the wastewater by a (FFIC) ratio flow control algorithm to chemical feed pumps. The algorithm is generated through software utilizing a programmable logic controller that is unique to that area where the chemical pumps are located.

D. The process loop sheet also indicates the requirement that the influent flow needs to be monitored continuously and totalized at both the operation building control room and the administration building control room. What is also important in the design is the fact that critical flow ranges are shown in the criteria blocks.

E. Some critical factors is the size of the magnetic flow meter, the flow range, etc, these meters need to be sized to be able to handle minimum, average daily and maximum flow requirements. If the influent pipe is to large for a proper reading of flow, at the minimum flow rate that the plant will encounter, then the magnetic flow meter needs to be smaller than the actual pipe size. This is handled by the mechanical pipe contractor providing pipe reducers and increasers to facilitate the magnetic flow meter's installation.

F. At all times if one field device is controlling another field device, for instance, the flow meter controlling a composite sampler, then the unique number for each device should be identified at both the flow meter loop sheet and the composite sampler loop sheet. This prevents a misunderstanding of which flow meter is controlling which composite sampler.

1A. There are many distinct differences and advantages between the individual Instrumentation Process Loop Sheet that I created and the loop sheets by others that are combined with their process flow diagrams.
1. Distinct differences are as follows:
a. Each piece of field equipment is identified by exact type, size, what division in the contract is responsible for providing that particular piece of equipment, and what is it used for in the process.
b. This becomes important due to the many types of equipment that could be used in a design. For instance, if a flow meter was to be used for measuring discharge flow from a pump station, either a Magnetic Flow Meter, Propeller Flow Meter, Venturi Flow Tube, or a Thermal Dispersion Type could be used.
c. In order to know what type of meter or any other requirement, a person would need to go though a time consuming review of the specifications to see if this information is provided or go to the Civil and Mechanical contract drawings to review piping drawings.
d. One of the more important key differences in my creation is the detail of information on how a particular piece of equipment actually performs at a given situation. For Instance, if a flow meter was to be use to flow pace an influent process sampler, that signal input from that flow meter would be shown on a Instrumentation Process Loop Sheet going to another Instrumentation Process Loop Sheet that has the influent process sampler identified with all its criteria.
2. The advantages are as follows:
a. Unnecessary time consumption is avoided during client or construction meetings when discussing process equipment and control parameters.
b. If a piece of equipment was to be added or removed, all the work that is needed for change with an Instrumentation Process Loop Sheet is to remove it from the drawing. Others would have to remove their piece of equipment and also correct their process diagram. If a process diagram was very busy then time consumption which is actual labor cost would increase due to the complexity of change.
What would happen if two or more of the same type of devices were used? All that needs to be done on the Instrumentation Process Loop Sheet is to add a different quantity above in the description block. Others would have to change their process diagram dramatically.
c. Due to many common types of equipment and controls in both Water and Wastewater Plants, that standardizing the Instrumentation Process Loop Sheets would be very easy. If someone wanted to create for instance, a general Magnetic Flow Meter Loop Sheet and save it in a particular data base then all anyone would need to do is download it add it to the drawing and with minor changes on the description add a new size, quantity, and its process description.
